(19) United States
(12) Patent Application Publication
(10) Pub. No.: US 2021/0133843 A1
(43) Pub. Date: May 6, 2021

(54) METHOD FOR PROVIDING ONLINE-TO-OFFLINE INTERNET E-COMMERCE SERVICE USING FABRIC UNIQUE IDENTIFIER

(71) Applicant: Hi Ju JANG, Seoul (KR)

(72) Inventor: Hi Ju JANG, Seoul (KR)

(21) Appl. No.: 16/638,746

(22) PCT Filed: Jun. 5, 2018
(86) PCT No.: PCT/KR2018/006411

§ 371 Date: Feb. 12, 2020

(30) Foreign Application Priority Data
Aug. 16, 2017 (KR) 10-2017-0103421

(51) Int. Cl. G06Q 30/06

(52) U.S. Cl. CPC G06Q 30/0623; G06Q 30/0603; G06Q 30/0641; G06Q 30/0619; G06Q 30/0633

(57) ABSTRACT

Provided is a method for providing an online-to-offline Internet e-commerce service using a fabric unique identifier, comprising the steps of, receiving and storing an identification number of fabric and data of the fabric mapped to the identification number of the fabric from at least one fabric registration terminal, assigning a fabric unique identifier to the stored identification number of the fabric, assigning and storing the fabric unique identifier for at least one article made of the fabric, receiving, from a search terminal, a searcher for searching for articles uploaded to a web page, an application page, a program, or an application that is provided by an online-to-offline e-commerce server, transmitting a list of articles corresponding to the searcher and the fabric unique identifier of the article to the search terminal and transmitting a location where samples of the fabric identified by the fabric unique identifier are present offline, and when selecting and purchasing any one of the list of articles from the search terminal, proceeding with the procedure according to the purchase of the search terminal.

### TECHNICAL FIELD

The present invention relates to a method of providing an offline store-associated internet shopping mall service using fabric unique identifiers, a method for identifying fabrics of online products in an offline store.

### BACKGROUND ART

Recent flourishing online shopping malls are replacing a number of offline shopping malls. Customers who are wondering what fabrics are used for products visit an offline store to experience the feel and look but, for purchase, they use online shopping malls. This renders offline shopping malls harder to run.

A membership offline store may provide its product samples to customers. Korean Patent Application Publication No. 2009-0103033 (published on Oct. 1, 2009) discloses a configuration in which a membership offline shopping mall issues authentication keys to select customers so that the customers may receive product samples using the authentication keys, thereby freeing advertisers from the need for sending out samples while meeting the needs for customers who desire to get samples before deciding to order.

However, the above method still fails to let customers know what fabrics have been used for products and, even if learning, they will check in an offline store and try to find the minimum price offer online. Thus, the method would never help offline malls flourish again. Customers tend to stay away from stores whose pricing is just a penny higher than the others. As such, it is hard to expect loyalty from customers.

### DETAILED DESCRIPTION OF THE INVENTION

### Technical Problems

According to an embodiment of the present invention, there may be provided a method of providing an offline store-associated internet shopping mall service using unique fabric identifiers. In the method, an offline store provides a fabric sample book to customers to allow them to identify fabric when they use an online shopping mall, and the offline store does not display or introduce final products to lead customers to the online shopping mall. For each fabric, a unique fabric identifier is used, instead of the unique number of the fabric. The unique fabric identifier is available only in the corresponding website. The method prevents losing customers from keen lowest price competitions. However, the objects of the embodiments are not limited thereto, and other objects may also be present.

### Means to Address Problems

To achieve the foregoing objects, an embodiment of the present invention includes receiving a unique number of a fabric and data for the fabric mapped to the unique fabric number from at least one fabric registering terminal and storing the fabric unique number and the fabric data, assigning a unique fabric identifier to the stored unique fabric number, assigning the unique fabric identifier to at least one product made of the fabric and storing the unique fabric identifier, receiving a searcher searching for a product uploaded on a webpage, app page, program, or application provided from the offline-associated shopping mall server, from a searching terminal, transmitting the unique fabric identifier of the product and a product list corresponding to the searcher to the searching terminal and transmitting an offline location where a fabric sample identified with the unique fabric identifier is present, and when any one on the product list is selected and purchased by the searching terminal, proceeding with a process according to the purchase by the searching terminal.

### Effects of the Invention

According to an embodiment of the present invention, there may be provided a method of providing an offline store-associated internet shopping mall service using unique fabric identifiers. In the method, an offline store provides a fabric sample book to customers to allow them to identify fabric when they use an online shopping mall, and the offline store does not display or introduce final products to lead customers to the online shopping mall. For each fabric, a unique fabric identifier is used, instead of the unique number of the fabric. The unique fabric identifier is available only in the corresponding website. The method prevents losing customers from keen lowest price competitions. Further, the method enables securing customers' loyalty.

### BRIEF DESCRIPTION OF THE DRAWINGS

FIG. 1 is a view illustrating a configuration of a system of providing an offline store-associated internet shopping mall service using unique fabric identifiers according to an embodiment of the present invention;

FIG. 2 is a block diagram illustrating an offline-associated shopping mall server as shown in FIG. 1;

FIG. 3 is a view illustrating an example of identifying a fabric offline after searching for a product on a searching terminal according to an embodiment of the present invention;

FIG. 4 is a view illustrating an example of searching for a product after checking a fabric on a searching terminal according to an embodiment of the present invention;

FIG. 5 is a view illustrating a process of data transmission/reception between components in a system of providing an offline store-associated internet shopping mall service using unique fabric identifiers, as shown in FIG. 1, according to an embodiment of the present invention; and

FIG. 6 is a flowchart illustrating operations of a method of providing an offline store-associated internet shopping mall service using unique fabric identifiers according to an embodiment of the present invention.

### MODE TO PRACTICE THE INVENTION

Hereinafter, exemplary embodiments of the inventive concept will be described in detail with reference to the accompanying drawings. The inventive concept, however, may be modified in various different ways, and should not be construed as limited to the embodiments set forth herein. Like reference denotations may be used to refer to the same or similar elements throughout the specification and the drawings. However, the present invention may be implemented in other various forms and is not limited to the embodiments set forth herein. For clarity of the disclosure, irrelevant parts are removed from the drawings, and similar reference denotations are used to refer to similar elements throughout the specification.

In embodiments of the present invention, when an element is “connected” with another element, the element may be “directly connected” with the other element, or the element may be “electrically connected” with the other element via an intervening element. When an element “comprises” or “includes” another element, the element may further include, but rather than excluding, the other element, and the terms “comprise” and “include” should be appreciated as not excluding the possibility of presence or adding one or more features, numbers, steps, operations, elements, parts, or combinations thereof.

When the measurement of an element is modified by the term “about” or “substantially,” if a production or material tolerance is provided for the element, the term “about” or “substantially” is used to indicate that the element has the same or a close value to the measurement and is used for a better understanding of the present invention or for preventing any unscrupulous infringement of the disclosure where the exact or absolute numbers are mentioned. As used herein, “step of” A or “step A-ing” does not necessarily mean that the step is one for A.

As used herein, the term “part” may mean a unit or device implemented in hardware, software, or a combination thereof. One unit may be implemented with two or more hardware devices or components, or two or more units may be implemented in a single hardware device or component.

As used herein, some of the operations or functions described to be performed by a terminal or device may be, instead of the terminal or device, performed by a server connected with the terminal or device. Likewise, some of the operations or functions described to be performed by a server may be performed by a terminal or device connected with the server, instead of the server.

As used herein, some of the operations or functions described to be mapped or matched with a terminal may be interpreted as mapping or matching the unique number of the terminal, which is identification information about the terminal, or personal identification information.

Hereinafter, embodiments of the disclosure are described in detail with reference to the accompanying drawings.

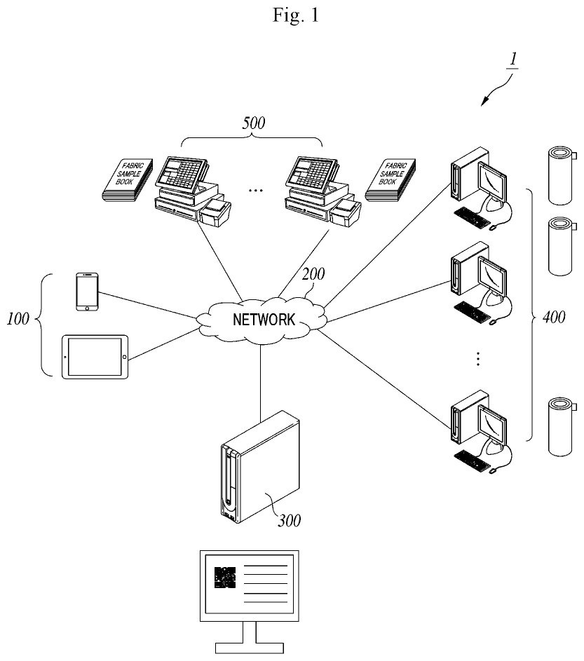

FIG. 1 is a view illustrating a configuration of a system of providing an offline store-associated internet shopping mall service using unique fabric identifiers according to an embodiment of the present invention. Referring to FIG. 1, a system 1 of providing an offline store-associated internet shopping mall service using unique fabric identifiers may include a searching terminal 100, an offline-associated shopping mall server 300, a fabric registering terminal 400, and an offline franchisee terminal 500. However, the system 1 of providing an offline store-associated internet shopping mall service using unique fabric identifiers, of FIG. 1, is merely an example, and the scope of the present invention is not limited by FIG. 1.

The components of FIG. 1 are generally connected together via a network 200. For example, referring to FIG. 1, the searching terminal 100 may be connected with the offline-associated shopping mall server 300 via a network 200. The searching terminal 100 may be connected with the fabric registering terminal 400 via the network 200. The offline-associated shopping mall server 300 may be connected with the searching terminal 100, the fabric registering terminal 400, and the offline franchisee terminal 500 via the network 200. The fabric registering terminal 400 may be connected with the offline-associated shopping mall server 300 and the offline franchisee terminal 500 via the network 200. The offline franchisee terminal 500 may be connected with the offline-associated shopping mall server 300 and the fabric registering terminal 400 via the network 200.

Here, “network” 200 means a connecting structure to enable exchanging of information between nodes, such as a plurality of terminals and servers. Examples of such network 200 may include, but are not limited to, a 3rd Generation Partnership Project (3GPP) network, a Long Term Evolution (LTE) network, a Long Term Evolution-Advanced (LTE-A) network, a 5th Generation Partnership Project (5GPP) network, a World Interoperability for Microwave Access (WIMAX) network, an Internet network, a Local Area Network (LAN) network, a Wireless LAN network, a Wide Area Network (WAN) network, a Personal Area Network (PAN) network, a Bluetooth network, an NFC network, a satellite broadcast network, an analog broadcast network, and a Digital Multimedia Broadcasting (DMB) network.

The searching terminal 100 may be a user's terminal which accesses webpages, app pages, applications, or programs provided from the offline-associated shopping mall server 300. In this case, the searching terminal 100 may be a terminal of a user who identifies a fabric offline while searching for a product or, after identifying a fabric offline, searches for a product. The searching terminal 100 may be a terminal of a user who resells products purchased from a shopping mall provided from the offline-associated shopping mall server 300, as second-hand ones, on the shopping mall. The searching terminal 100 may be a terminal of a user who, upon failing an offline shopping mall, applies for a fabric sample book after pre-paying for a rent deposit for the fabric sample book on the offline-associated shopping mall server 300. The searching terminal 100 may be a terminal that outputs products formed of a fabric read or scanned offline from the fabric sample book, the prices, and the reviews or evaluation in an augmented reality (AR) overlaying manner. In this case, the searching terminal 100 may be a terminal that selects and stores a corresponding product and then provides a direct link to the product, and forcedly switches to the link. Of course, the present invention is not limited to the forced switching.

Here, the searching terminal 100 may be implemented as a computer which may access a remote server or terminal via the network 200. Here, the computer may be, e.g., a settop box, web browser-equipped laptop computer or desktop computer. Here, the searching terminal 100 may be implemented as a terminal which may access a remote server or terminal via the network 200. The searching terminal 100 may be, e.g., a portable mobile wireless communication device examples of which may include navigation devices, a Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, a smartphone, a smartpad, tablet PC, or any other various types of handheld wireless communication devices.

The offline-associated shopping mall server 300 may be a server that receives unique fabric numbers and detailed product information about fabrics from the fabric registering terminal 400. In this case, the offline-associated shopping mall server 300 may generate unique fabric identifiers corresponding to the unique fabric numbers to prevent other shopping malls from searching for the unique fabric numbers and may map the unique fabric identifiers to the unique fabric numbers and fabric detailed product information and store the mapped information. The offline-associated shopping mall server 300 may be a server that registers the offline franchisee terminal 500 and distributes fabric sample books to allow fabric samples to be identified with the naked eye offline. The user who searches for a product on the searching terminal 100 may be hesitant to purchase the produce because he does not directly see the product. In such a case, the offline-associated shopping mall server 300 may transmit the location of the offline franchisee terminal 500 with samples of the fabric to the searching terminal 100 and, in this case, the offline-associated shopping mall server 300 may authenticate the searching terminal 100 and transmit a unique fabric identifier to the searching terminal 100. In contrast, if the searching terminal 100 has first identified and searched for the fabric, the offline-associated shopping mall server 300 may transmit classified products formed of the fabric to the searching terminal 100. When the searching terminal 100 sells a product purchased on the shopping mall, the offline-associated shopping mall server 300 may verify the fabric using the unique fabric identifier and allows the product to be sold as a second-hand one. When the searching terminal 100 desires a fabric sample, the offline-associated shopping mall server 300 may output a shipping request to allow a fabric sample book to be rented out after a deposit is paid for.

In this case, the offline-associated shopping mall server 300 may be implemented as a computer capable of accessing a remote server or terminal via the network 200. Here, the computer may be, e.g., a or web browser-equipped laptop computer or desktop computer.

The fabric registering terminal 400 may be a terminal of a seller who sells fabric. The fabric registering terminal 400 may be a terminal that transmits, e.g., detailed information about the fabric, and the manufacturer or manufacturing factory for making products using the fabric.

Here, the fabric registering terminal 400 may be implemented as a computer which may access a remote server or terminal via the network 200. Here, the computer may be, e.g., a or web browser-equipped laptop computer or desktop computer. Here, the fabric registering terminal 400 may be implemented as a terminal which may access a remote server or terminal via the network 200. The fabric registering terminal 400 may be, e.g., a portable mobile wireless communication device examples of which may include navigation devices, a Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, a smartphone, a smartpad, tablet PC, or any other various types of handheld wireless communication devices.

The offline franchisee terminal 500 may be a terminal equipped in an offline store. In this case, the offline franchisee terminal 500 may be a terminal that authenticates and authorizes the searching terminal 100 via the unique fabric identifier of the searching terminal 100. Upon scanning the unique fabric identifier of the searching terminal 100, the offline franchisee terminal 500 may output information about the fabric sample book including the corresponding fabric.

Here, the offline franchisee terminal 500 may be implemented as a computer which may access a remote server or terminal via the network 200. Here, the computer may be, e.g., a point-of-sale (PoS), or web browser-equipped laptop computer or desktop computer. Here, the fabric registering terminal 400 may be implemented as a terminal which may access a remote server or terminal via the network 200. The offline franchisee terminal 500 may be, e.g., a portable mobile wireless communication device examples of which may include navigation devices, a Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, a smartphone, a smartpad, tablet PC, or any other various types of handheld wireless communication devices.

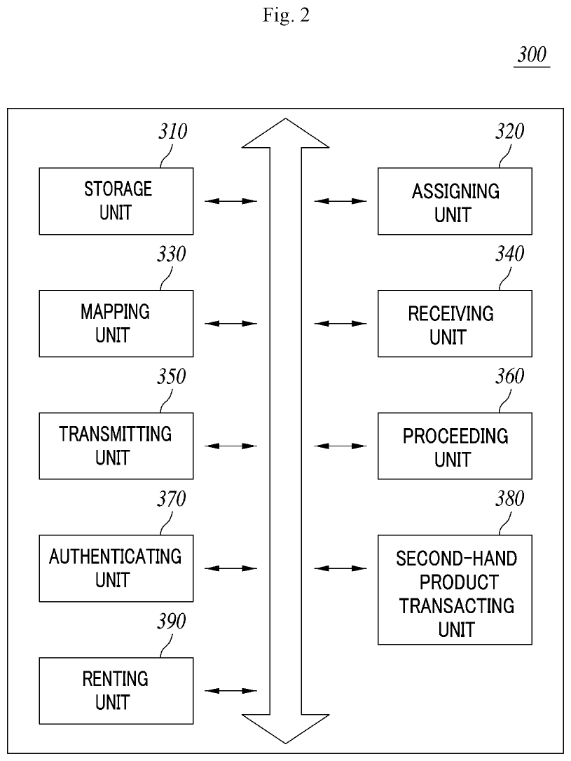

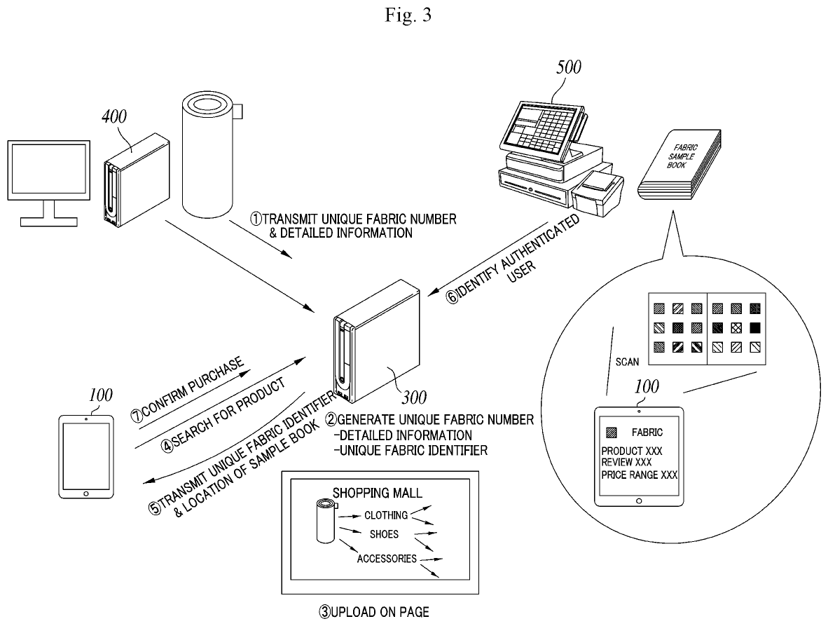

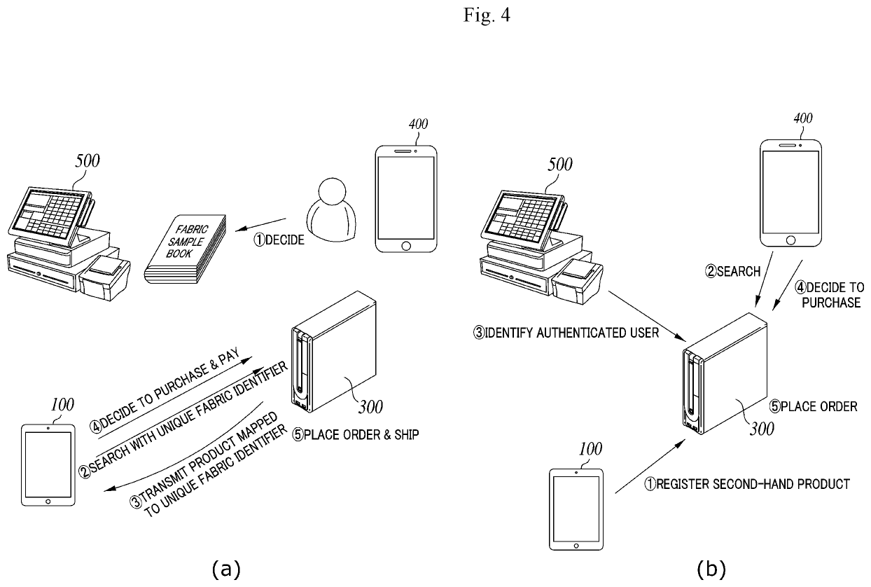

FIG. 2 is a block diagram illustrating an offline-associated shopping mall server as shown in FIG. 1. FIG. 3 is a view illustrating an example of identifying a fabric offline after searching for a product on a searching terminal according to an embodiment of the present invention. FIG. 4 is a view illustrating an example of searching for a product after checking a fabric on a searching terminal according to an embodiment of the present invention.

Referring to FIG. 2, according to an embodiment of the present invention, the offline-associated shopping mall server 300 may include a storage unit 310, an assigning unit 320, a mapping unit 330, a receiving unit 340, a transmitting unit 350, a proceeding unit 360, an authenticating unit 370, a second-hand product transacting unit 380, and a renting unit 390.

According to an embodiment of the present invention, if the offline-associated shopping mall server 300 or another server (not shown) interworking with the offline-associated shopping mall server 300 transmits an application, program, app page, or webpage for an offline store-associated internet shopping mall service using unique fabric identifiers to the searching terminal 100, the fabric registering terminal 400, and the offline franchisee terminal 500, the searching terminal 100, the fabric registering terminal 400, and the offline franchisee terminal 500 may install or open the application, program, app page, or webpage for the offline store-associated internet shopping mall service using unique fabric identifiers. A service program may be driven or run on the searching terminal 100 using a script executed on a web browser. Here, the web browser may be a program or application that enables use of world wide web (WWW) services or that receives and shows hypertext written in the hypertext mark-up language (HTML), and the web browser may include, e.g., Netscape, Explorer, or Chrome. The term “application” may mean an application executed on the terminal, and the application may include, e.g., an app running on a mobile terminal, e.g., a smartphone.

Here, connection to network 200 means that the searching terminal 100, the offline-associated shopping mall server 300, the fabric registering terminal 400, and the offline franchisee terminal 500 generates a communication object at a communication contact for communication with a terminal connected via the network 200. The offline-associated shopping mall server 300 may exchange data via the communication object.

According to an embodiment of the present invention, offline store-associated internet shopping mall services using unique fabric identifiers may encompass when a customer searches an internet shopping mall for a product and offline searches a fabric sample book for the product, when the customer looks into the fabric sample book offline and then searches the internet shopping mall, when the customer, when unable to identify offline, pre-pays for a deposit and rents the fabric sample book, and when the customer registers a second-hand product after fabric authentication. However, without limitation to the above cases, more examples may be included. An example fabric sample book is shown below in Table 1.

TABLE 1

| clothing | shoes | bags | bedding | socks | caps | neckties | scarfs | handkerchiefs |
|---|---|---|---|---|---|---|---|---|
| identification | identification | identification | identification | identification | identification | identification | identification | identification |
| number 1 | number 1 | number 1 | number 1 | number 1 | number 1 | number 1 | number 1 | number 1 |
| 3 | 3 | 3 | 3 | 3 | 3 | 3 | 3 | 3 |
| 5 | 5 | 5 | 5 | 5 | 5 | 5 | 5 | 5 |
| 7 | 7 | 7 | 7 | 7 | 7 | 7 | 7 | 7 |
| 9 | 9 | 9 | 9 | 9 | 9 | 9 | 9 | 9 |
| 11 | 11 | 11 | 11 | 11 | 11 | 11 | 11 | 11 |
| 13 | 13 | 13 | 13 | 13 | 13 | 13 | 13 | 13 |
| 15 | 15 | 15 | 15 | 15 | 15 | 15 | 15 | 15 |
| 17 | 17 | 17 | 17 | 17 | 17 | 17 | 17 | 17 |
| 19 | 19 | 19 | 19 | 19 | 19 | 19 | 19 | 19 |
| 21 | 21 | 21 | 21 | 21 | 21 | 21 | 21 | 21 |
| 23 | 23 | 23 | 23 | 23 | 23 | 23 | 23 | 23 |
| 25 | 25 | 25 | 25 | 25 | 25 | 25 | 25 | 25 |
| 27 | 27 | 27 | 27 | 27 | 27 | 27 | 27 | 27 |

The fabric sample book may be configured to, when the customer authenticated for membership by the company enters the unique fabric identifier provided from the company's internet shopping mall, allow the customer to learn various pieces of information about the product fabric, identical or similar to those in the fabric sample book. In such a system, if the customer enters the unique identifier of the fabric sample provided from the internet scan parameter after getting through a user authentication process, only the identification number of the fabric sample of the corresponding product among various identification numbers may be lighted on. If the customer processes the lighted-on identification number, the fabric sample of the product may slide out the automatic display machine to allow the customer to look and feel by touching, as does a CD ROM tray.

The storage unit 310 may receive unique fabric numbers and fabric data mapped to the unique fabric numbers from at least one fabric registering terminal 400 and store them.

The assigning unit 320 may assign unique fabric identifiers to the stored unique fabric numbers. In this case, the unique fabric identifiers may differ from the unique fabric numbers. In other words, the unique fabric numbers may be ones provided to distinguish between fabrics, and may also be searched for by other shopping malls or customers. Identification codes or identifiers different in system from the unique fabric numbers may be assigned to be searched for on the page of the present invention but not on other shopping malls. This may be done so because if doing searches with the same unique number may not avoid losing customers on the minimum price competitions.

The mapping unit 330 may assign a unique fabric identifier to at least one produce made of fabric and store the same. The mapping unit 330 may enable a pointer to indicate other product made of the same fabric based on the unique fabric identifier, thereby allowing for creation of connected labels.

The receiving unit 340 may receive a searcher searching for the product uploaded on the webpage, app page, program or application provided from the offline-associated shopping mall server 300 from the searching terminal 100.

Upon searching, the searching terminal 100 may add at least one, or at least one combination, of design, style, size, manufacturer, manufacturing factory, and price range, as an AND condition, to the unique fabric identifier. The offline-associated shopping mall server 300 may transmit the results meeting the AND condition entered on the searching terminal 100, to the searching terminal 100.

For example, since the type or finishing quality of sewing or the design, as well as fabric itself, is also important, the manufacturer, manufacturing company (for the purpose of guaranteeing quality, e.g., finishing), and design may be searched as well. For example, if user A prefers products from manufacturer B, and manufacturer B uses factory C, when user A selects fabric D, fabric D allows products produced from factory C to be searched for. Products from manufacturer B may be evaluated high due to the brand value of manufacturer B. Thus, if user A does a search with fabric D without specifying the manufacturer, products of a similar quality may be searched for.

The transmitting unit 350 may transmit a list of products corresponding to the searcher and the unique fabric identifier for the product to the searching terminal 100, and the transmitting unit 350 may transmit an offline location with a sample of the fabric, which is identified by the unique fabric identifier.

In this case, when the transmitting unit 350 transmits the list of products corresponding to the searcher and the unique fabric identifier for the product to the searching terminal 100 and transmits the offline location with a sample of the fabric, which is identified by the unique fabric identifier, the unique fabric identifier of the product may be transmitted to the searching terminal 100 when the user of the searching terminal 100 is authenticated.

If the offline franchisee terminal owning a sample book for the fabric authenticates by scanning or reading the unique fabric identifier of the searching terminal 100, the transmitting unit 350 may transmit, to the offline franchisee terminal, an authorization to rent out the fabric sample book.

Further, when the transmitting unit 350 transmits the list of products corresponding to the searcher and the unique fabric identifier for the product to the searching terminal 100 and transmits the offline location with a sample of the fabric, which is identified by the unique fabric identifier, if there is no offline store with a fabric sample within a preset radius of the location of the searching terminal 100, other store(s) that sell products made of the fabric assigned the unique identifier may be searched for.

Further, the transmitting unit 350 may transmit information about the other store to the searching terminal 100 and, if the location of the searching terminal 100 matches the location of the other store, the transmitting unit 350 may control the searching terminal 100 to identify a product with the unique fabric identifier and overlay the identifier in AR.

For example, it is assumed that user A who desires to see fabric B feels urged to immediately purchase rather than ordering a sample book with fabric B by paying for a deposit. In this case, the transmitting unit 350 searches for another store possessing a product made of the fabric and transmits it to user A, so that user A may quickly decide whether to purchase. However, if user a desired to see fabric C of product C, and fabric C has been used for the same or a similar product to product C, such transmission is not performed. This is why user A, i.e., a potential customer, may leave for other stores. Of course, without limitation thereto, the same product may be searched for and transmitted.

When any one product on the product list is selected and purchased on the searching terminal 100, the proceeding unit 360 may proceed with a process for purchase on the searching terminal 100.

The authenticating unit 370 may receive a user authentication request from the searching terminal 100 for which the unique fabric identifier has been verified in the offline store owning the fabric sample book after the mapping unit 330 has assigned the unique fabric identifier to at least one product made of the fabric and store it. The authenticating unit 370 may also authenticate the user, who searches for the unique fabric identifier, via the searching terminal 100.

If authentication is complete, the authenticating unit 370 may classify the product list with the unique fabric identifier, uploaded onto the webpage, app page, program, or application provided from the offline-associated shopping mall server 300, and transmit it to the searching terminal 100.

The product list with the unique fabric identifier may be a result of classifying and searching based on at least one, or a combination of at least one, of manufacturer, manufacturing factory, design, product, feature, and color.

After the proceeding unit 360 selects and purchases any one product on the product list on the searching terminal 100 and proceeds with the process for purchase on the searching terminal 100, the second-hand product transacting unit 380 may receive an event of requesting to sell a second-hand product, which has been purchased on the searching terminal 100, from the searching terminal 100. The second-hand product transacting unit 380 may also authenticate the unique fabric identifier of the second-hand product on the searching terminal 100. The second-hand product transacting unit 380 may upload the authenticated second-hand product so that it may start to sell.

Upon searching for a fabric sample with the unique fabric identifier in the offline store owning a sample book for the fabric, the searching terminal 100 may scan or read a plurality of unique identifiers marked on the fabric sample book. The unique identifiers may be identifiers, e.g., QR codes, which are not scannable or searchable by other shopping malls. However, it is apparent that without limitations to QR code, other identifiers may also be used.

If the plurality of unique identifiers scanned or read have a unique identifier that matches the unique fabric identifier, the searching terminal 100 may overlay an indicator for indicating the matching unique identifier on the screen of the searching terminal 100.

For example, if the fabric sample book has a total of 100 fabric samples, the user of the searching terminal 100, who finds one or several desired fabrics, may have to scan through the sample book. The searching terminal 100 may scan the QR codes and use augmented reality technology, compare the scanned QR codes with the QR code of the sample which the searching terminal 100 finds and, if there is a matching QR code, the searching terminal 100 may quickly find the sample.

Upon searching for fabric samples with the unique fabric identifier in the offline affiliated store owning the fabric sample book, the searching terminal 100 may scan or read a plurality of unique identifiers marked on the fabric sample book and may output products made of the fabric with the scanned or read unique identifier on the screen of the searching terminal 100, with at least one, or a combination of at least one, of the image, price, evaluation, and review data overlaid thereon.

In other words, if the searching terminal 100 is already in the offline store and is searching the fabric sample book and directly outputs, on the searching terminal 100, the products made of the fabric, which the searcher is looking at with her eyes, the need for going to online and offline both is removed. Thus, if the searching terminal 100 searches for sample A and other samples B, C, and D are also being read on the searching terminal 100, the products made of fabrics, e.g., B, C, and D, may be displayed in an AR manner on the searching terminal 100, with prices or reviews overlaid thereon, thereby leading customers to consumption.

Further, when the transmitting unit 350 transmits the list of products corresponding to the searcher and the unique fabric identifier for the product to the searching terminal 100 and transmits the offline location with a sample of the fabric, which is identified by the unique fabric identifier, if there is no offline store with a fabric sample within a preset radius of the location of the searching terminal 100, the renting unit 390 may receive a upfront payment for a deposit for renting out the fabric sample book.

For example, when user A desires to see fabrics B, C, and D but there is no fabric sample book for fabrics B, C, and D around user A, user A may feel annoyed about visiting a shopping mall far away. User A may request to rent a sample book for fabrics B, C, and D by pre-paying for a deposit (in this case, an actual payment does not occur when a preset condition is met (e.g., when the sample book is not returned)). A payment for the pre-paid fee may be complete when user A does not return but is not when user A returns.

Thus, if the fabric sample book shipped to the address of the searching terminal 100 is not returned, the renting unit 390 may collect the deposit.

An offline store-associated internet shopping mall service using unique fabric identifiers, configured as above, is described below with reference to FIGS. 3 and 4.

Referring to FIG. 3, \textcircled{1} if the fabric registering terminal 400 transmits unique fabric numbers and detailed information, \textcircled{2} upon storing the unique fabric numbers and the detailed information, the offline-associated shopping mall server 300 generates and stores unique fabric identifiers and creates a database for the unique fabric identifiers.

Further, \textcircled{3} the offline-associated shopping mall server 300 registers a corresponding fabric and products made of the fabric in the webpage, app page, program, or application, and updates it. \textcircled{4} When the searching terminal 100 searches for a product, \textcircled{5} the offline-associated shopping mall server 300 authenticates the searching terminal 100 and transmits the unique fabric identifier and the location of the fabric sample book so that the searcher of the searching terminal 100 may identify the fabric.

\textcircled{6} If the offline franchisee terminal 500 scans the unique fabric identifier output on the searching terminal 100, the offline-associated shopping mall server 300 outputs such information as, e.g., what kind of sample book it is or the number of pages, to the offline franchisee terminal 500.

Then, \textcircled{7} the offline-associated shopping mall server 300 may output information for ordering if the searching terminal 100 confirms to purchase.

If finding where the desired fabric is located in the fabric sample book, the searching terminal 100 may overlay the same in an AR manner, identify what products are made of other fabrics, prices, or reviews using the unique fabric identifier displayed on the screen of the current recording, and if a desired one is found, move directly to the website that sells the product.

Referring to FIG. 4, (a) \textcircled{1} if the searching terminal 100 determines a fabric after looking at the fabric sample book in the offline affiliated store and is then authenticated to receive the unique fabric identifier, \textcircled{2} the result of search corresponding to the searched-for unique fabric identifier \textcircled{3} is transmitted to the searching terminal 100 by the offline-associated shopping mall server 300.

At this time, \textcircled{4} if the searching terminal 100 decides to purchase, the offline-associated shopping mall server 300 places an order and proceeds with a shipping process.

(b) Meanwhile, it is assumed that the user of the searching terminal 100 resells the product (assigned a unique fabric identifier) he has purchased before on the shopping mall. In this case, \textcircled{1} the searching terminal 100 may be authorized to register a second-hand produce after authenticated for the unique fabric identifier. Then, \textcircled{2} before another customer who has searched for the product decides to purchase, he may directly see the fabric from the fabric sample book in the offline affiliated store. In this case, the other customer also follows the same process that has been performed on the searching terminal 100 for purchase. In other words, \textcircled{3} the offline franchisee terminal 500 may identify whether he is an authenticated user and may output where the sample is. Further, \textcircled{4} if the other customer decides to purchase, \textcircled{5} the offline-associated shopping mall server 300 may place an order.

In this case, the offline store may be a store separately prepared to display the fabric sample book (for, e.g., clothing, shoes, bags, or bedding) associated with the internet shopping mall or may be a store combined with a coffee shop, laundromat, or convenience store.

First, if a search is done on the internet shopping mall using the unique identifiers of the fabric (e.g., clothing, shoes, bags, or bedding) sample book, information about various products per manufacturer, design, function, or feature, made of the fabric may be provided.

The process of accessing the internet and then searching offline may be performed in the order of: accessing the company's internet shopping mall-->shopping for various products-->deciding a product desired to purchase-->identifying the unique fabric identifier of the desired product-->receiving authentication of the unique identifier-->visiting the company's offline store-->showing the unique fabric identifier received from the internet shopping mall-->learning information, e.g., color, texture, or other features, by looking at the fabric of the desired product-->deciding to purchase the product-->reaccessing the company's internet shopping mall on a computer or mobile device to order and pay. However, the present invention is not limited thereto, and it will be apparent that there may be implemented in other various manners.

The process of identifying offline and then searching on the internet may be performed in the order of: visiting the company's offline store-->viewing various fabric sample books-->identifying color, texture, etc., and deciding a desired fabric-->identifying the unique identifier of the desired fabric-->receiving the unique identifier-->accessing the company's internet shopping mall-->searching with the unique fabric identifier received from the offline store-->learning information about all products (per manufacturer, per design, per function, or per feature) made of the desired fabric-->deciding to purchase the product-->ordering and paying on a computer or mobile device. However, the present invention is not limited thereto, and it will be apparent that there may be implemented in other various manners.

The process of reselling a product as a second-hand product may be performed in the order of: authentication of the unique fabric identifier on the company's second-hand clothing selling website and requesting the company's internet shopping mall to sell-->accessing the company's second-hand clothing selling website-->requesting to sell the second-hand clothes-->authentication of the unique fabric identifier of, e.g., the second-hand clothes-->starting to sell, e.g., the second-hand clothes-->a customer buying, e.g., the second-hand clothes accessing the company's internet shopping mall-->shopping for various pieces of second-hand clothing-->deciding second-hand clothes desired to purchase-->identifying the unique fabric identifier of the desired product-->receiving the unique identifier-->visiting the company's offline store-->showing the unique fabric identifier received from the internet shopping mall-->learning information, e.g., color, texture, or feature, by looking at the fabric of the desired product-->deciding to purchase the product-->reaccessing the company's internet shopping mall to order and pay, e.g., the second-hand clothes, on computer or mobile device. However, the present invention is not limited thereto, and it will be apparent that there may be implemented in other various manners.

The fabric sample book may include an electronic (digital) fabric sample book. The fabric may be fabric associated with the internet shopping mall (e.g., clothing, shoes, bags, bedding, aprons, socks, scarfs, caps, or neckties). To allow customers to access the fabric sample book in diversified manners, e.g., for customers who are far away from any offline store with the fabric sample book, the online shopping mall may provide a sample book rental service on a deposit, or mini (small) fabric sample books may be made and provided to the customers via mail or courier service, in association with the internet shopping mall. The internet shopping mall may directly sell the fabrics shown in the fabric sample book to the customers as is done by the product selling system in association with the internet shopping mall.

What is not described regarding the method of providing an offline store-associated internet shopping mall service using unique fabric identifiers in connection with FIGS. 2 to 4 is the same or easily inferred from what has been described regarding the method of providing an offline store-associated internet shopping mall service using unique fabric identifiers in connection with FIG. 1, and no detailed description thereof is thus presented.

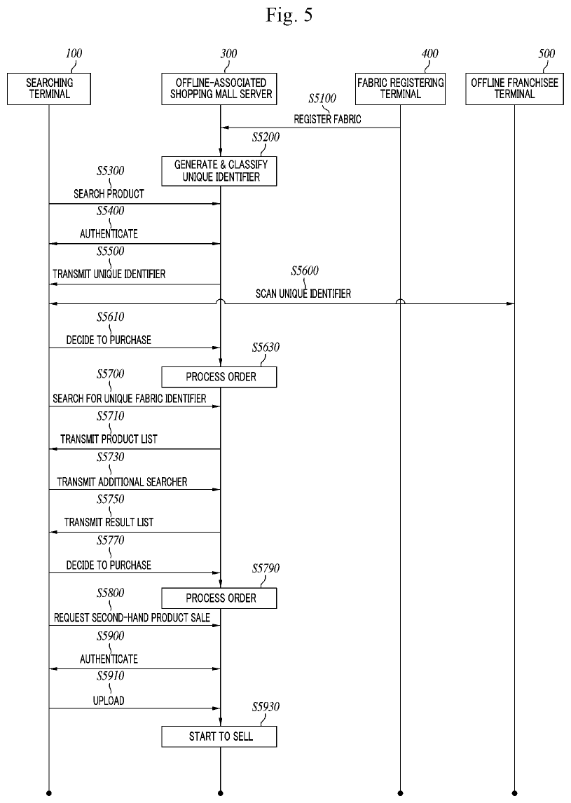

FIG. 5 is a view illustrating a process of data transmission/reception between components in a system of providing an offline store-associated internet shopping mall service using unique fabric identifiers, as shown in FIG. 1, according to an embodiment of the present invention. An example of data transmission and reception among the components is described below with reference to FIG. 5. However, embodiments of the disclosure are not limited thereto, and it is apparent to a skilled artisan that various changes or modifications may be made thereto.

Referring to FIG. 5, the fabric registering terminal 400 registers fabric and detailed information in the offline-associated shopping mall server 300 (S5100), and the offline-associated shopping mall server 300 generates and classifies unique identifiers (S5200).

If the searching terminal 100 searches for a product (S5300), the offline-associated shopping mall server 300 performs authentication (S5400) and transmit a unique identifier (S5500).

If the offline franchisee terminal 500 scans the unique identifier (S5600), the offline-associated shopping mall server 300 may transmit information about the fabric to the offline franchisee terminal 500.

Then, if the searching terminal 100 determines to purchase (S5610), the offline-associated shopping mall server 300 processes the order (S5630).

If the searching terminal 100 searches for a unique fabric identifier (S5700), the offline-associated shopping mall server 300 transmits a list of products made of the fabric (S5710). If the searching terminal 100 transmits an additional searcher (S5730), the offline-associated shopping mall server 300 does a search under the condition and transmits the result (S5750). If the searching terminal 100 determines to purchase (S5770), the offline-associated shopping mall server 300 processes the order (S5790).

If the searching terminal 100 requests to sell a second-hand product (S5800), the offline-associated shopping mall server 300 authorizes the second-hand product sale via authentication (S5900, S5910) and starts to sell (S5930).

The above-described steps S5100 to S5930 are merely an example, and embodiments of the disclosure are not limited thereto. In other words, the above-described steps S5100 to S5930 may be performed in a different order, or some of the steps may be simultaneously performed or omitted.

What is not described regarding the method of providing an offline store-associated internet shopping mall service using unique fabric identifiers in connection with FIG. 5 is the same or easily inferred from what has been described regarding the method of providing an offline store-associated internet shopping mall service using unique fabric identifiers in connection with FIGS. 1 to 4, and no detailed description thereof is thus presented.

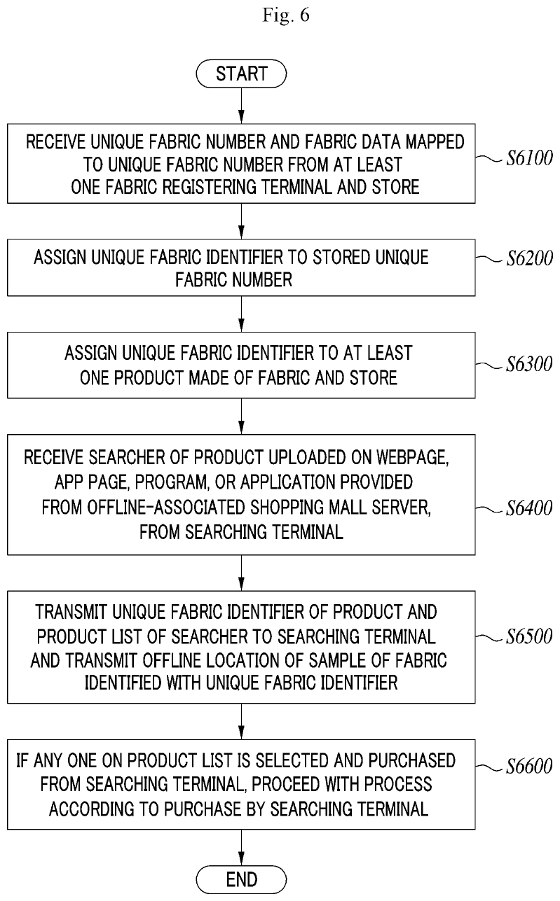

FIG. 6 is a flowchart illustrating operations of a method of providing an offline store-associated internet shopping mall service using unique fabric identifiers according to an embodiment of the present invention. Referring to FIG. 6, an offline-associated shopping mall server receives a subscription and book rental application from a delivery requesting terminal (S6100).

The offline-associated shopping mall server checks the stock for the requested book, identifies the location of the delivery requesting terminal (S6200), and calls a silver delivery terminal in charge of the identified location (S6300).

If the location of the silver delivery terminal is the same as the delivery location, and the user interface corresponding to the completion of book delivery is selected on the delivery requesting terminal, the offline-associated shopping mall server processes it as completion of delivery for the rental application (S6400) and counts the rental period for the delivered book (S6500).

If the counted rental period is a preset rental period, the offline-associated shopping mall server transmits a book collect message to the silver delivery terminal (S6600), and the silver delivery terminal transmits a response message corresponding to the book collect message. If the location of the silver delivery terminal matches the location of delivery, the offline-associated shopping mall server processes it as completion of collection of the delivered book (S6700).

What is not described regarding the method of providing an offline store-associated internet shopping mall service using unique fabric identifiers in connection with FIG. 6 is the same or easily inferred from what has been described regarding the method of providing an offline store-associated internet shopping mall service using unique fabric identifiers in connection with FIGS. 1 to 5, and no detailed description thereof is thus presented.

The method of providing an offline store-associated internet shopping mall service using unique fabric identifiers according to an embodiment described with reference to FIG. 6 may be implemented in the form of a recording medium or computer-readable medium containing computer-executable instructions or commands, such as an application or program module executable on a computer. The computer-readable medium may be an available medium that is accessible by a computer. The computer-readable storage medium may include a volatile medium, a non-volatile medium, a separable medium, and/or an inseparable medium. The computer-readable medium may include a computer storage medium. The computer storage medium may include a volatile medium, a non-volatile medium, a separable medium, and/or an inseparable medium that is implemented in any method or scheme to store computer-readable commands, data architecture, program modules, or other data or information.

According to an embodiment, the above-described method of providing an offline store-associated internet shopping mall service using unique fabric identifiers may be executed by an application installed on a terminal, including a platform equipped in the terminal or a program included in the operating system of the terminal), or may be executed by an application (or program) installed by the user on a master terminal via an application providing server, such as a web server, associated with the service or method, an application, or an application store server. According to an embodiment, the above-described method of providing an offline store-associated internet shopping mall service using unique fabric identifiers may be implemented in an application or program installed as default on the terminal or installed directly by the user and may be recorded in a recording medium or storage medium readable by a terminal or computer.

Although embodiments of the present invention have been described with reference to the accompanying drawings, It will be appreciated by one of ordinary skill in the art that the present disclosure may be implemented in other various specific forms without changing the essence or technical spirit of the present disclosure. Thus, it should be noted that the above-described embodiments are provided as examples and should not be interpreted as limiting. Each of the components may be separated into two or more units or modules to perform its function(s) or operation(s), and two or more of the components may be integrated into a single unit or module to perform their functions or operations.

It should be noted that the scope of the present invention is defined by the appended claims rather than the described description of the embodiments and include all modifications or changes made to the claims or equivalents of the claims.

1. A method of providing a shopping mall service executed on an offline-associated shopping mall server, the method comprising:
receiving a unique number of a fabric and data for the fabric mapped to the unique fabric number from at least one fabric registering terminal and storing the fabric unique number and the fabric data;
assigning a unique fabric identifier to the stored unique fabric number;
assigning the unique fabric identifier to at least one product made of the fabric and storing the unique fabric identifier;
receiving a searcher searching for a product uploaded on a webpage, app page, program, or application provided from the offline-associated shopping mall server, from a searching terminal;
transmitting the unique fabric identifier of the product and a product list corresponding to the searcher to the searching terminal and transmitting an offline location where a fabric sample identified with the unique fabric identifier is present; and
when any one on the product list is selected and purchased by the searching terminal, proceeding with a process according to the purchase by the searching terminal.

2. The method of claim 1, wherein transmitting the unique fabric identifier of the product and the product list corresponding to the searcher to the searching terminal and transmitting the offline location where the fabric sample identified with the unique fabric identifier is present includes:
transmitting the unique fabric identifier of the product to the searching terminal via user authentication on the searching terminal; and
if an offline franchisee terminal of an offline store with a sample book of the fabric performs the authentication by scanning or reading the unique fabric identifier of the searching terminal, transmitting an authorization for renting out the fabric sample book to the offline franchisee terminal.

3. The method of claim 1, further comprising:
after assigning the unique fabric identifier to at least one product made of the fabric and storing the unique fabric identifier, receiving an authentication request for user authentication from the searching terminal having identified the unique fabric identifier in an offline affiliated store with a sample book of the fabric;
performing authentication on a user searching for the unique fabric identifier via the searching terminal;
if the authentication is complete, classifying and transmitting the list of products with the unique fabric identifier uploaded on the web page, app page, program, or application provided from the offline-associated shopping mall server to the searching terminal.

4. The method of claim 3, wherein the list of the products with the unique fabric identifier is a result of classifying and searching according to at least one, or a combination of at least one, of manufacturer, manufacturing factory, design, product, feature, and color.

5. The method of claim 1, further comprising:
when any one on the product list is selected and purchased by the searching terminal, proceeding with the process according to the purchase by the searching terminal, receiving an event of requesting to sell a second-hand product which has been purchased on the searching terminal, from the searching terminal;
performing authentication on the unique fabric identifier of the second-hand product on the searching terminal; and
uploading the authenticated second-hand product and starting to sell the second-hand product.

6. The method of claim 1, wherein upon searching for a sample for the fabric with the unique fabric identifier in an offline affiliated store with a sample book of the fabric, the searching terminal scans or reads a plurality of unique identifiers marked on the fabric sample book and, if the plurality of unique identifiers scanned or read include a unique identifier matching the unique fabric identifier, overlays an indicator for indicating the matching unique identifier on a screen of the searching terminal.

7. The method of claim 1, wherein upon searching for a sample for the fabric with the unique fabric identifier in an offline affiliated store with a sample book of the fabric, the searching terminal scans or reads a plurality of unique identifiers marked on the fabric sample book and overlays at least one, or a combination of at least one, of image, price, evaluation, and review data for products made of the fabric with the scanned or read unique identifier on a screen of the searching terminal.

8. The method of claim 1, wherein transmitting the unique fabric identifier of the product and the product list corresponding to the searcher to the searching terminal and transmitting the offline location where the fabric sample identified with the unique fabric identifier is present includes:
if no sample of the fabric is present, offline, within a preset radius of the location of the searching terminal, receiving a pre-payment for a deposit for renting out a sample book for the fabric via the searching terminal; and
if the fabric sample book, after shipped to an address of the searching terminal, is not retuned, collecting the deposit.

9. The method of claim 1, wherein transmitting the unique fabric identifier of the product and the product list corresponding to the searcher to the searching terminal and transmitting the offline location where the fabric sample identified with the unique fabric identifier is present includes:
if no sample of the fabric is present, offline, within a preset radius of the location of the searching terminal, searching for another store selling a product made of the unique identifier-assigned fabric;
transmitting information about the other store to the searching terminal; and
if the location of the searching terminal matches the location of the other store, identifying the product with the unique fabric identifier in AR and overlaying the identifier.

10. The method of claim 1, wherein upon searching, the searching terminal adds at least one, or a combination of at least one, of design, style, size, manufacturer, manufacturing factory, and price range, as an AND condition along with the unique fabric identifier, and wherein the offline-associated shopping mall server transmits a result meeting the AND condition entered by the searching terminal to the searching terminal.
